(19) United States
(12) Patent Application Publication
(10) Pub. No.: US 2026/0331912 A1
(43) Pub. Date: Oct. 22, 2026

(54) MULTIDIMENSIONAL EVALUATION METHOD FOR AI GAME ALGORITHMS IN SYNCHRONOUS RECOVERY OF POWER NETWORKS

(71) Applicant: Beihang University, Beijing (CN)

(72) Inventors: Qi WU, Beijing (CN); Yilong CHEN, Beijing (CN)

(73) Assignee: Beihang University, Beijing (CN)

(21) Appl. No.: 19/212,777

(22) Filed: May 20, 2025

(30) Foreign Application Priority Data
Apr. 17, 2025 (CN) 202510481531.5

(51) Int. Cl. H02J 3/00

(52) U.S. Cl. CPC H02J 3/001; H02J 2103/30

(57) ABSTRACT

The provided is a multidimensional evaluation method for AI game algorithms in synchronous recovery of power networks. The method achieves a systematic quantitative assessment of AI algorithms for resisting high-power electromagnetic pulse-induced loss of synchronization, covering both system-level and node-level indicators, while supporting adaptive testing across multiple topological scenarios. The method includes: constructing a standard topology library for power grid models containing IEEE standard nodes and derivative topologies thereof, creating dynamic scenarios, and solving power system differential equations using a fourth-order Runge-Kutta method to generate benchmark data; based on spatiotemporal alignment between the benchmark data and prediction results of the AI game algorithms, calculating multi-level indicators and performing dynamic weight allocation; generating a comprehensive score through weighted aggregation of system-level and node-level indicators; and creating a capability report featuring the comprehensive score, indicator decomposition, and visual charts.

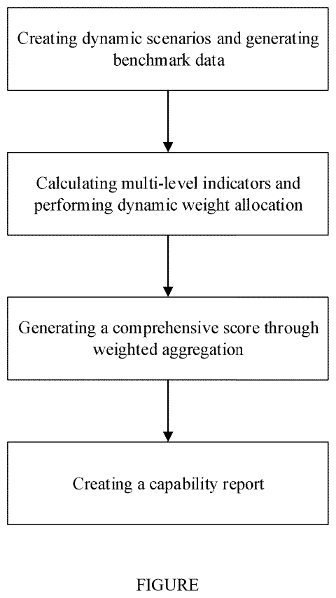

### CROSS-REFERENCE TO THE RELATED APPLICATIONS

This application is based upon and claims priority to Chinese Patent Application No. 202510481531.5, filed on Apr. 17, 2025, the entire contents of which are incorporated herein by reference.

### TECHNICAL FIELD

The present invention relates to the field of power network recovery evaluation, in particular to a multidimensional evaluation method for AI game algorithms in synchronous recovery of power networks.

### BACKGROUND

With the continuous expansion of power system scale and the increasing level of intelligence, the safety and stability of power networks in extreme electromagnetic environments, such as high-altitude electromagnetic pulses (HEMP), have become increasingly prominent. Strong electromagnetic pulses possess extremely high field strength and ultra-steep rise times, capable of inducing powerful transient currents and voltages in power systems, leading to severe consequences such as equipment damage, erroneous protection actions, and control system failures, potentially triggering large-scale blackout incidents. Therefore, how to effectively assess and enhance the anti-interference capability and recovery ability of power systems in HEMP environments has become an important research topic in the field of power system safety.

In recent years, the application of artificial intelligence (AI) technology in power systems has become increasingly widespread, particularly showing great potential in areas such as stability analysis, fault diagnosis, and recovery control. AI algorithms, such as deep learning and reinforcement learning, are used to predict the dynamic responses and recovery processes of power systems under the influence of HEMP. However, there are still many issues regarding the performance evaluation of these AI algorithms.
(1) Unidimensional evaluation: Current methods primarily rely on the overall network synchronous recovery time error (such as mean square error, MSE) as the core metric, which fails to reflect local dynamic characteristics such as phase deviation and frequency deviation at nodes. Additionally, there is a lack of quantitative analysis of oscillation mode differences between regions, making it difficult to assess the adaptability of AI algorithms in complex topologies.
(2) Insufficient scenario coverage: Existing evaluation methods typically use fixed test scenarios (such as the single IEEE 30-bus topology) and do not consider the dynamic changes in different power grid scales and topological structures. Additionally, there is a lack of systematic sampling of HEMP parameters (such as pulse intensity and incident angle), resulting in inadequate test coverage.
(3) Hierarchical disconnection issue: Existing methods have not established a correlation analysis model between system-level macro indicators and node-level micro indicators, resulting in a lack of hierarchical evaluation results. For example, it is not possible to quantify the relationship between the degree of a specific node and the overall network synchronous recovery time.
(4) Incomparability of results: Existing AI algorithms, such as Long Short-Term Memory Network (LSTM) and Graph Neural Network (GNN), have made some progress in predicting synchronous recovery in power grids, but there is a lack of unified performance evaluation standards. The output data from different AI algorithms lacks standardized alignment methods, making horizontal comparisons difficult. Consequently, there is a lack of targeted recommendations for algorithm optimization, resulting in evaluation outcomes that are not directly useful for guiding algorithm improvements.

### SUMMARY

The present invention aims to overcome the shortcomings of the prior art by providing a multidimensional evaluation method for AI game algorithms in synchronous recovery of power networks. The method achieves a systematic quantitative assessment of AI algorithms for resisting high-power electromagnetic pulse-induced loss of synchronization, covering both system-level and node-level indicators, while supporting adaptive testing across multiple topological scenarios.

To achieve the above objective, the invention adopts the following technical scheme. The invention provides a multidimensional evaluation method for AI game algorithms in synchronous recovery of power networks, including:
S1, constructing a standard topology library for power grid models containing Institute of Electrical and Electronics Engineers (IEEE) standard nodes and derivative topologies thereof, creating dynamic scenarios, and solving power system differential equations using a fourth-order Runge-Kutta method to generate benchmark data;
S2, based on spatiotemporal alignment between the benchmark data and prediction results of the AI game algorithms, calculating multi-level indicators and performing dynamic weight allocation;
S3, generating a comprehensive score through weighted aggregation of system-level and node-level indicators; and
S4, creating a capability report featuring the comprehensive score, indicator decomposition, and visual charts.

Further, constructing a standard topology library for power grid models containing IEEE standard nodes and derivative topologies thereof, and creating dynamic scenarios specifically includes:
constructing a standard topology library containing IEEE standard nodes and derived topologies thereof, each topology containing node coordinates, branch impedances, and generator parameters, and for a generator at an i^{th} node, parameters including initial frequency

$${ω}_{0}^{( i )}$$

and initial phase

$${θ}_{0}^{( i )}$$

being set; and
generating high-altitude electromagnetic pulses with different parameters, waveforms of the high-altitude electromagnetic pulses being approximated using double-exponential function waveforms, with the time-domain expression as follows:

$$E ( t ) = 1.05 \times {E}_{0} ( {e}^{- α t} - {e}^{- β t} ) ;$$

where E₀ represents the peak electric field strength, and α and β are the parameters for leading and trailing edges of the pulse respectively.

Further, solving power system differential equations using a fourth-order Runge-Kutta method to generate benchmark data specifically includes:
using the fourth-order Runge-Kutta method to solve power system differential equations and output benchmark data

$${T}_{ref}^{( k )} , {θ}_{ref}^{( i )} ( t ) ,$$

and

$${f}_{r e f}^{( i )} ( t ) ;$$

where

$${T}_{r e f}^{( k )}$$

represents the benchmark recovery time obtained from fourth-order Runge-Kutta numerical simulation;

$${θ}_{r e f}^{( i )} ( t )$$

denotes the phase angle of an i^{th} node at time t obtained from the fourth-order Runge-Kutta numerical simulation; and

$${f}_{r e f}^{( i )} ( t )$$

represents the frequency of the i^{th} node at time t obtained from the fourth-order Runge-Kutta numerical simulation.

Further, calculating multi-level indicators specifically includes:
calculating an overall network synchronous recovery time error rate:

$${T}_{e r r} = \frac{1}{{N}_{t e s t}} {\sum }_{k = 1}^{{N}_{t e s t}} \vert \frac{{T}_{AI}^{( k )} - {T}_{r e f}^{( k )}}{{T}_{r e f}^{( k )}} \vert \times 100 \% ;$$

where

$${T}_{AI}^{( k )}$$

represents the recovery time for a k^{th} scenario predicted by AI, Nₜₑₛₜ denotes the number of scenarios generated by simulation, and Tₑᵣᵣ indicates the overall network synchronous recovery time error rate;
calculating a root mean square error of a node phase deviation of the node-level indicators:

$$Δ {θ}_{R M S} = \frac{1}{{N}_{T} {N}_{n o d e}} {\sum }_{i = 1}^{{N}_{n o d e}} {\sum }_{t = 1}^{{N}_{T}} {( {θ}_{AI}^{( i )} - {θ}_{r e f}^{( i )} ( t ) )}^{2} ;$$

where N_{T} represents the total number of points in a time series, determined by a simulation duration and a step size, N_{node} indicates the total number of nodes in a power grid,

$${θ}_{AI}^{( i )}$$

signifies the phase angle of the i^{th} node at time t predicted by AI, and Δθ_{RMS} represents the root mean square error of phase deviations for all nodes; and
calculating a maximum absolute error of a node frequency deviation of the node-level indicators:

$$Δ {f}_{max} = {max}_{i , t} \vert {f}_{AI}^{( i )} ( t ) - {f}_{r e f}^{( i )} ( t ) \vert ;$$

where

$${f}_{AI}^{( i )} ( t )$$

denotes the frequency of the i^{th} node at time t predicted by AI, used to capture extreme deviations in frequency prediction by the AI algorithm.

Further, performing dynamic weight allocation specifically includes:
dynamically allocating weights of the system-level and node-level indicators using the following formula:

$${ω}_{s y s} = \frac{ln ( \frac{{N}_{n o d e}}{30} )}{ln ( \frac{200}{30} )} , {ω}_{n o d e} = 1 - {ω}_{s y s} ;$$

where ω_{sys} represents the weight of the system-level indicators, and ω_{mode} denotes the weight of the node-level indicators.

Further, generating a comprehensive score through weighted aggregation of system-level and node-level indicators specifically includes:
generating the comprehensive score through weighted aggregation of system-level and node-level indicators with the calculation formula as follows:

$$S = {ω}_{s y s} ( 1 - \frac{{T}_{e r r}}{0.2} ) + {ω}_{n o d e} \cdot ( 1 - \frac{Δ {θ}_{R M S}}{0.1} + \frac{1}{1 + Δ {f}_{max}} ) ;$$

where S represents the comprehensive score result.

Further, creating a capability report specifically includes:
the capability report featuring the comprehensive score, indicator decomposition, and visual charts;
comprehensive score and indicator decomposition:
outputting evaluation levels based on scoring criteria, with S≥0.9 indicating excellent, 0.8≤S≤0.9 signifying good, and S<0.8 representing average, which needs improvement;
outputting the contribution of the system-level indicators:

$${ω}_{sys} ( 1 - \frac{{T}_{err}}{0.2} ) ;$$

outputting the contribution of the node-level indicators:

$${ω}_{node} \cdot ( 1 - \frac{Δ {θ}_{RMS}}{0.1} + \frac{1}{1 + Δ {f}_{max}} ) ;$$

visual charts:
visualizing the performance in terms of time accuracy

$$( 1 - \frac{{T}_{err}}{0.2} ) ,$$

phase deviation prediction result

$$1 - \frac{Δ {θ}_{RMS}}{0.1} ,$$

and frequency deviation prediction results

$$\frac{1}{1 + Δ {f}_{max}}$$

using a radar chart; and
plotting time-domain waveforms of phase angles and frequencies for selected nodes to compare AI predicted values with baseline values.

The invention has the following beneficial effects.

The invention realizes a multi-level dynamic evaluation system that links system-level (time error) and node-level (phase and frequency deviation) dual indicators, breaking through the limitations of traditional unidimensional evaluations. This approach can simultaneously reflect global performance and local dynamic characteristics. Coupled with a dynamic weight allocation mechanism, it adapts to the assessment needs of power grids of varying scales.

The invention provides a dynamic weight adaptive mechanism that utilizes a logarithmic function weight formula, allowing for a smooth transition of weights based on the scale of the power grid. This ensures that the evaluation results better align with actual needs. For example, in a 200-node grid, the weight of system-level indicators increases to 70%, avoiding a one-size-fits-all evaluation.

The invention achieves a high coverage of scenarios by employing a uniform random sampling method to generate power grid-high-power electromagnetic pulse coupling test scenarios. By flexibly configuring the power grid topology, high-power electromagnetic pulse parameters, and operational conditions, a comprehensive test scenario library is constructed, ensuring high coverage and representativeness.

### BRIEF DESCRIPTION OF THE DRAWINGS

The FIGURE is a flowchart of a multidimensional evaluation method for AI game algorithms in synchronous recovery of power networks according to an embodiment of the present invention.

### DETAILED DESCRIPTION OF THE EMBODIMENTS

In order to make the objectives, technical schemes and advantages of the embodiments of the invention clearer, the technical schemes in the embodiments of the invention are clearly and completely described below with reference to the accompanying drawings in the embodiments of the invention.

The invention provides a multidimensional evaluation method for AI game algorithms in synchronous recovery of power networks, as shown in the FIGURE, which includes the following steps.
S1, constructing a standard topology library for power grid models containing IEEE standard nodes and derivative topologies thereof, creating dynamic scenarios, and solving power system differential equations using a fourth-order Runge-Kutta method to generate benchmark data.

Dynamic scenario construction and benchmark data generation are foundational aspects of the invention, aimed at generating diverse power grid-high-power electromagnetic pulse coupling test scenarios and obtaining benchmark data through high-precision numerical simulation. First, a standard topology library is constructed,
which contains IEEE standard node systems (such as IEEE 30-bus and IEEE 57-bus) and derived topologies thereof, with a maximum node count of 200. The range of node count N is [30, 200], following a uniform distribution. Each topology includes the following data:
node coordinates (for visualization);
branch impedance: Zₗᵢₙₑ;
generator parameters: for a generator at the i^{th} node, the following parameters are set: initial frequency ω₀⁽ⁱ⁾ (in Hz) uniformly distributed in the range of [−0.1, 0.1]; and initial phase θ₀⁽ⁱ⁾ (in rad) uniformly distributed in the range of [—0.5π, 0.5π].

Then, high-altitude electromagnetic pulses with different parameters are generated. Here, waveforms of the high-altitude electromagnetic pulses are approximated using double-exponential function waveforms, with the time-domain expression as follows:

$$E ( t ) = 1.05 \times {E}_{0} ( {e}^{- α t} - {e}^{- β t} ) ;$$

where E₀ represents the peak electric field strength, and α and β are the parameters for leading and trailing edges of the pulse respectively. The incident electric field strength E₀ (in kV/m) is in the range of [10, 100]. α And β are assigned values of 4×10⁶ and 4.76×10⁸ respectively.

Next, benchmark data generation is performed by using the fourth-order Runge-Kutta method to solve power system differential equations. A time step of 0.01 ms is used to ensure high temporal resolution, and the simulation lasts for 10 seconds to cover both transient and steady-state processes. The benchmark data

$${T}_{ref}^{( k )} , {θ}_{ref}^{( i )} ( t ) ,$$

and

$${f}_{ref}^{( i )} ( t )$$

is output,
where

$${T}_{ref}^{( k )}$$

represents the benchmark recovery time (in seconds) obtained from fourth-order Runge-Kutta numerical simulation;

$${θ}_{ref}^{( i )} ( t )$$

denotes the phase angle (in rad) of an i^{th} node at time t obtained from the fourth-order Runge-Kutta numerical simulation; and

$${f}_{ref}^{( i )} ( t )$$

represents the frequency (in Hz) of the i^{th} node at time t obtained from the fourth-order Runge-Kutta numerical simulation.
S2, based on spatiotemporal alignment between the benchmark data and prediction results of the AI game algorithms, calculating multi-level indicators and performing dynamic weight allocation.

Calculating multi-level indicators specifically includes:
calculating an overall network synchronous recovery time error rate:

$${T}_{err} = \frac{1}{{N}_{test}} {\sum }_{k = 1}^{{N}_{test}} \vert \frac{{τ}_{AI}^{( k )} - {T}_{ref}^{( k )}}{{T}_{ref}^{( k )}} \vert \times 100 \% ;$$

where

$${T}_{AI}^{( k )}$$

represents the recovery time (in seconds) for a k^{th} scenario predicted by AI, Nₜₑₛₜ denotes the number of scenarios generated by simulation, with a default value of 500, and Tₑᵣᵣ indicates the overall network synchronous recovery time error rate; the smaller the value of Tₑᵣᵣ, the better the system performance indicators of the AI algorithm in time prediction;
calculating a root mean square error of a node phase deviation of the node-level indicators:

$$Δ {θ}_{RMS} = \sqrt{\frac{1}{{N}_{T} {N}_{node}} {\sum }_{i = 1}^{{N}_{node}} {\sum }_{t = 1}^{{N}_{T}} {( {θ}_{AI}^{( i )} - {θ}_{ref}^{( i )} ( t ) )}^{2}} ;$$

where N_{T} represents the total number of points in a time series, determined by a simulation duration (default: 10 seconds) and a step size (0.01 ms), N_{node} indicates the total number of nodes in a power grid, which varies between 30 and 200 based on different generated scenarios,

$${θ}_{AI}^{( i )}$$

signifies the phase angle (in rad) of the i^{th} node at time t predicted by AI, and Δθ_{RMS} represents the root mean square error of phase deviations for all nodes; the smaller the value of Δθ_{RMS}, the more accurate the AI algorithm is in angle prediction, typically requiring Δθ_{RMS}<0.1 rad; and
calculating a maximum absolute error of a node frequency deviation of the node-level indicators:

$$Δ {f}_{max} = {max}_{i , t} \vert {f}_{AI}^{( i )} ( t ) - {f}_{ref}^{( i )} ( t ) \vert ;$$

where

$${f}_{AI}^{( i )} ( t )$$

denotes the frequency (in Hz) of the i^{th} node at time t predicted by AI, used to capture extreme deviations in frequency prediction by the AI algorithm, typically requiring Δƒₘₐₓ<1 Hz.

The specific method for dynamic weight allocation is as follows.

To accommodate the variation in the number of generated power grid nodes from 30 to 200, weights of the system-level and node-level indicators are dynamically allocated using the following formula:

$${ω}_{s y s} = \frac{ln ( \frac{{N}_{node}}{30} )}{ln ( \frac{200}{30} )} , {ω}_{node} = 1 - {ω}_{sys} ;$$

where ω_{sys} represents the weight of the system-level indicators, ranging from 0 to 1; ω_{node} represents the weight of the node-level indicators, also ranging from 0 to 1; and ln(·) indicates the natural logarithm function which ensures that weights transition smoothly as the number of nodes increases. This design of dynamic weight generation is based on complex network theory, where an increase in node count shifts the dominant factors of system dynamics from local characteristics to global characteristics. For small-scale power grids (e.g., 30 nodes), node-level indicator weights are higher, with assessments focusing more on local dynamic characteristics; for large-scale power grids (e.g., 200 nodes), system-level indicator weights are higher, emphasizing overall network performance.
S3, generating a comprehensive score through weighted aggregation of system-level and node-level indicators.

The comprehensive score is generated through weighted aggregation of system-level and node-level indicators with the calculation formula as follows:

$$S = {ω}_{sys} ( 1 - \frac{{T}_{err}}{0.2} ) + {ω}_{node} \cdot ( 1 - \frac{Δ {θ}_{RMS}}{0.1} + \frac{1}{1 + Δ {f}_{max}} ) ;$$

where S represents the comprehensive score result. The score range is S∈[0,1]. The closer the value is to 1, the better the performance of the AI algorithm being tested.
S4, creating a capability report featuring the comprehensive score, indicator decomposition, and visual charts.

Comprehensive score and indicator decomposition: Evaluation levels are output based on scoring criteria, with S≥0.9 indicating excellent, 0.8≤S≤0.9 signifying good, and S<0.8 representing average, which needs improvement. The contribution of the system-level indicators is output:

$${ω}_{sys} ( 1 - \frac{{T}_{err}}{0.2} ) .$$

The contribution of the node-level indicators is output:

$${ω}_{node} \cdot ( 1 - \frac{Δ {θ}_{RMS}}{0.1} + \frac{1}{1 + Δ {f}_{max}} ) .$$

Visualized radar chart: Performance is shown in the following dimensions: time accuracy

$$( 1 - \frac{{T}_{err}}{0.2} ) ,$$

phase deviation prediction result

$$1 - \frac{Δ {θ}_{RMS}}{0.1} ,$$

and frequency deviation prediction result

$$\frac{1}{1 + Δ {f}_{max}}$$

Each dimension has a value range of [0, 1], with values closer to 1 indicating better performance.

Time-domain waveform comparison chart: Time-domain waveforms of phase angles and frequencies for key nodes are plotted to compare AI predicted values with baseline values.

The above are only preferred embodiments of the invention. It should be understood that the invention is not limited to the forms disclosed herein, should not be regarded as excluding other embodiments, but can be used in various other combinations, modifications and improvements, and can be modified by the above teaching or the technology or knowledge in related fields within the scope of the inventive concept described herein. The modifications and changes made by those skilled in the art without departing from the spirit and scope of the invention should be within the scope of protection of the appended claims.

1. A multidimensional evaluation method for AI game algorithms in synchronous recovery of power networks, comprising following steps:
S1, constructing a standard topology library for power grid models containing Institute of Electrical and Electronics Engineers (IEEE) standard nodes and derivative topologies of the IEEE standard nodes, creating dynamic scenarios, and solving power system differential equations using a fourth-order Runge-Kutta method to generate benchmark data;
S2, based on spatiotemporal alignment between the benchmark data and prediction results of the AI game algorithms, calculating multi-level indicators and performing dynamic weight allocation;
S3, generating a comprehensive score through weighted aggregation of system-level and node-level indicators; and
S4, creating a capability report featuring the comprehensive score, indicator decomposition, and visual charts.

2. The multidimensional evaluation method for the AI game algorithms in the synchronous recovery of the power networks according to claim 1, wherein the step of constructing the standard topology library for the power grid models containing the IEEE standard nodes and the derivative topologies of the IEEE standard nodes, and creating the dynamic scenarios comprises:
constructing the standard topology library containing the IEEE standard nodes and the derived topologies of the IEEE standard nodes, each topology containing node coordinates, branch impedances, and generator parameters, and for a generator at an i^{th} node, parameters comprising initial frequency
$${ω}_{0}^{( i )}$$
and initial phase
$${θ}_{0}^{( i )}$$
being set; and
generating high-altitude electromagnetic pulses with different parameters, waveforms of the high-altitude electromagnetic pulses being approximated using double-exponential function waveforms, with a time-domain expression as follows:
$$E ( t ) = 1.05 \times {E}_{0} ( {e}^{- α t} - {e}^{- β t} ) ;$$
where E₀ represents a peak electric field strength, and α and β are parameters for leading and trailing edges of the high-altitude electromagnetic pulse respectively.

3. The multidimensional evaluation method for the AI game algorithms in the synchronous recovery of the power networks according to claim 1, wherein the step of solving the power system differential equations using the fourth-order Runge-Kutta method to generate the benchmark data comprises:
using the fourth-order Runge-Kutta method to solve the power system differential equations and output the benchmark data
$${T}_{ref}^{( k )} , {θ}_{ref}^{( i )} ( t ) ,$$
and
$${f}_{ref}^{( i )} ( t ) ;$$
where
$${T}_{ref}^{( k )}$$
represents benchmark recovery time obtained from fourth-order Runge-Kutta numerical simulation;
$${θ}_{ref}^{( i )} ( t )$$
denotes a phase angle of an i^{th} node at time t obtained from the fourth-order Runge-Kutta numerical simulation; and
$${f}_{ref}^{( i )} ( t )$$
represents a frequency of the i^{th} node at time t obtained from the fourth-order Runge-Kutta numerical simulation.

4. The multidimensional evaluation method for the AI game algorithms in the synchronous recovery of the power networks according to claim 3, wherein the step of calculating the multi-level indicators comprises:
calculating an overall network synchronous recovery time error rate:
$${T}_{e r r} = \frac{1}{{N}_{t e s t}} {\sum }_{k = 1}^{{N}_{t e s t}} \vert \frac{{τ}_{AI}^{( k )} - {τ}_{ref}^{( k )}}{{τ}_{ref}^{( k )}} \vert \times 100 \% ;$$
where
$${T}_{AI}^{( k )}$$
represents recovery time for a k^{th} scenario predicted by AI, Nₜₑₛₜ denotes the number of scenarios generated by simulation, and Tₑᵣᵣ indicates the overall network synchronous recovery time error rate;
calculating a root mean square error of a node phase deviation of the node-level indicators:
$$Δ {θ}_{R M S} = \sqrt{\frac{1}{{N}_{T} {N}_{n o d e}} {\sum }_{i = 1}^{{N}_{n o d e}} {\sum }_{t = 1}^{{N}_{T}} {( {θ}_{AI}^{( i )} - {θ}_{r e f}^{( i )} ( t ) )}^{2}} ;$$
where N_{T} represents total number of points in a time series, determined by a simulation duration and a step size, N_{node} indicates total number of nodes in a power grid,
$${θ}_{AI}^{( i )}$$
signifies the phase angle of the i^{th} node at time t predicted by AI, and Δθ_{RMS} represents the root mean square error of phase deviations for all nodes; and
calculating a maximum absolute error of a node frequency deviation of the node-level indicators:
$$Δ {f}_{max} = {max}_{i , t} \vert {f}_{AI}^{( i )} ( t ) - {f}_{ref}^{( i )} ( t ) \vert ;$$
where
$${f}_{AI}^{( i )} ( t )$$
denotes the frequency of the i^{th} node at time t predicted by AI, configured to capture extreme deviations in frequency prediction by AI algorithm.

5. The multidimensional evaluation method for the AI game algorithms in the synchronous recovery of the power networks according to claim 4, wherein the step of performing the dynamic weight allocation comprises:
dynamically allocating weights of the system-level and node-level indicators using the following formula:
$${ω}_{s y s} = \frac{ln ( \frac{{N}_{node}}{30} )}{ln ( \frac{200}{30} )} , {ω}_{node} = 1 - {ω}_{s y s} ;$$
where ω_{sys} represents the weight of the system-level indicators, and ω_{node} denotes the weight of the node-level indicators.

6. The multidimensional evaluation method for the AI game algorithms in the synchronous recovery of the power networks according to claim 5, wherein the step of generating the comprehensive score through the weighted aggregation of the system-level and node-level indicators comprises:
generating the comprehensive score through the weighted aggregation of the system-level and node-level indicators with the calculation formula as follows:
$$S = {ω}_{s y s} ( 1 - \frac{{T}_{e r r}}{0.2} ) + {ω}_{n o d e} \cdot ( 1 - \frac{Δ {θ}_{R M S}}{0.1} + \frac{1}{1 + Δ {f}_{max}} ) ;$$
where S represents a comprehensive score result.

7. The multidimensional evaluation method for the AI game algorithms in the synchronous recovery of the power networks according to claim 6, wherein creating the capability report comprises:
the capability report featuring the comprehensive score, the indicator decomposition, and the visual charts;
the comprehensive score and the indicator decomposition:
outputting evaluation levels based on scoring criteria, with S≥0.9 indicating excellent, 0.8≤S≤0.9 signifying good, and S<0.8 representing average, which needs improvement;
outputting a contribution of the system-level indicators:
$${ω}_{s y s} ( 1 - \frac{{T}_{e r r}}{0.2} ) ;$$
outputting a contribution of the node-level indicators:
$${ω}_{n o d e} \cdot ( 1 - \frac{Δ {θ}_{R M S}}{0.1} + \frac{1}{1 + Δ {f}_{max}} ) ;$$
visual charts:
visualizing a performance in terms of time accuracy
$$( 1 - \frac{{T}_{e r r}}{0.2} ) ,$$
phase deviation prediction results
$$1 - \frac{Δ {θ}_{R M S}}{0.1} ,$$
and frequency deviation prediction results
$$\frac{1}{1 + Δ {f}_{max}}$$
using a radar chart; and
plotting time-domain waveforms of phase angles and frequencies for selected nodes to compare AI predicted values with baseline values.
